(19) United States
(12) Patent Application Publication
(10) Pub. No.: US 2026/0239085 A1
(43) Pub. Date: Aug. 13, 2026

(54) APPARATUS, METHOD AND COMPUTER PROGRAM

(71) Applicant: Nokia Technologies Oy, Espoo (FI)

(72) Inventors: Hans Thomas Höhne, Helsinki (FI); Vismika Maduka Ranasinghe Mudiyanselage, Oulu (FI); Amaanat Ali, Espoo (FI); Ahmad Masri, Espoo (FI); Mahmood Reza Alizadeh Ashrafi, Espoo (FI); Sakira Hassan, Espoo (FI); Fahad Syed Muhammad, Orsay (FR)

(73) Assignee: Nokia Technologies Oy, Espoo (FI)

(21) Appl. No.: 19/472,902

(22) PCT Filed: Apr. 7, 2023
(86) PCT No.: PCT/EP2023/059339

§ 371 Date: Oct. 6, 2025

(51) Int. Cl. H04W 24/10; H04W 36/00

(52) U.S. Cl. CPC H04W 24/10; H04W 36/0088

(57) ABSTRACT

There is provided an apparatus comprising means for means for receiving a measurement configuration at the apparatus to record measurements in a recording window based on a trigger, means for recording one or more measurements based on the measurement configuration in the recording window, means for determining, based on a condition, to report the recorded measurements after the recording window and means for reporting the recorded measurements based on the determining.

### FIELD

The present application relates to a method, apparatus, system and computer program and in particular but not exclusively to measurement reporting suspension.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is Universal Mobile Telecommunications System (UMTS) Terrestrial Radio Access Network (UTRAN) (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP). Other examples of communication systems include 5G-Advanced (NR Rel-18 and beyond) and 6G.

### SUMMARY

In a first aspect there is provided an apparatus comprising means for receiving a measurement configuration at the apparatus to record measurements in a recording window based on a trigger, means for recording one or more measurements based on the measurement configuration in the recording window, means for determining, based on a condition, to report the recorded measurements after the recording window and means for reporting the recorded measurements based on the determining.

The apparatus may comprise means for receiving an indication at the apparatus from the network to suspend measurement reporting for at least one of a given cell or beam for a time period, wherein the trigger comprises the indication and means for suspending measurement reporting based on the indication.

The indication to suspend measurement reporting may comprise a validity timer.

The validity timer may comprise at least one of the following: the time period or a start time and a stop time.

The apparatus may comprise means for suspending measurement reporting upon receiving the indication to suspend measurement reporting or based on a subsequent event trigger, if the validity timer comprises the time period.

The measurement configuration may be for the at least one beam or cell for which measurement reporting has been suspended.

The measurement configuration may further comprise at least one beam or cell which has not been suspended.

The recording window may be a function of the validity timer.

The apparatus may comprise means for determining a prediction of an event and means for determining to record measurements during the recording window based on the prediction of the event.

The apparatus may comprise means for determining the prediction of the event at the user equipment using a machine learning model, the prediction having an associated confidence value, the confidence value indicating a confidence level of the machine learning model for the prediction.

The apparatus may comprise means for receiving an indication from the network of the predicted event, the prediction having an associated confidence value, the confidence value indicating a confidence level of the machine learning model for the prediction.

The confidence value may be below a given threshold.

The periodicity of the measurements may depend on the confidence value.

The apparatus may comprise means for determining to report the recorded measurements if the predicted event does not occur.

The apparatus may comprise means for determining that an event has occurred with no prediction and means for reporting the recorded measurements from the user equipment to the network based on the determining.

In a second aspect there is provided an apparatus comprising means for providing a measurement configuration to a user equipment from a network to record measurements in a recording window based on a trigger and means for receiving recorded measurements from the user equipment.

The apparatus may comprise means for determining, based on a first machine learning model, to suspend measurement reporting for at least one given cell or beam for a first time period and means for providing an indication to the user equipment to suspend measurement reporting for the at least one of a given cell or beam, wherein the trigger comprises the indication.

The indication to suspend measurement reporting may comprise a validity timer.

The recording window may be a function of the validity timer.

The validity timer may comprise at least one of the following: a time period or a start time and a stop time.

The measurement configuration may be for the at least one beam or cell for which measurement reporting has been suspended.

The measurement configuration may further comprise at least one beam or cell which has not been suspended.

The apparatus may comprise means for determining a prediction of an event at the network and means for providing an indication from the network to the further apparatus of the event prediction for use in determining to record measurements.

The apparatus may comprise means for determining the prediction of the event using a second machine learning model, the prediction having an associated confidence value, the prediction having an associated confidence value, the confidence value indicating a confidence level of the machine learning model for the prediction.

The confidence value may be below a given threshold.

The periodicity of the measurements may depend on the confidence value.

In a third aspect there is provided a method comprising receiving a measurement configuration at an apparatus to record measurements in a recording window based on a trigger, recording one or more measurements based on the measurement configuration in the recording window, determining, based on a condition, to report the recorded measurements after the recording window and reporting the recorded measurements based on the determining.

The method may comprise receiving an indication at the apparatus from the network to suspend measurement reporting for at least one of a given cell or beam for a time period, wherein the trigger comprises the indication and suspending measurement reporting based on the indication.

The indication to suspend measurement reporting may comprise a validity timer.

The validity timer may comprise at least one of the following: the time period or a start time and a stop time.

The method may comprise suspending measurement reporting upon receiving the indication to suspend measurement reporting or based on a subsequent event trigger, if the validity timer comprises the time period.

The measurement configuration may be for the at least one beam or cell for which measurement reporting has been suspended.

The measurement configuration may further comprise at least one beam or cell which has not been suspended.

The recording window may be a function of the validity timer.

The method may comprise determining a prediction of an event and determining to record measurements during the recording window based on the prediction of the event.

The method may comprise determining the prediction of the event at the user equipment using a machine learning model, the prediction having an associated confidence value, the confidence value indicating a confidence level of the machine learning model for the prediction.

The method may comprise receiving an indication from the network of the predicted event, the prediction having an associated confidence value, the confidence value indicating a confidence level of the machine learning model for the prediction.

The confidence value may be below a given threshold.

The periodicity of the measurements may depend on the confidence value.

The method may comprise determining to report the recorded measurements if the predicted event does not occur.

The method may comprise determining that an event has occurred with no prediction and reporting the recorded measurements from the user equipment to the network based on the determining.

In a fourth aspect there is provided a method comprising providing a measurement configuration to a user equipment from a network to record measurements in a recording window based on a trigger and receiving recorded measurements at the network from the user equipment.

The method may comprise determining, based on a first machine learning model, to suspend measurement reporting for at least one given cell or beam for a first time period and providing an indication to the user equipment to suspend measurement reporting for the at least one of a given cell or beam, wherein the trigger comprises the indication.

The indication to suspend measurement reporting may comprise a validity timer.

The recording window may be a function of the validity timer.

The validity timer may comprise at least one of the following: a time period or a start time and a stop time.

The measurement configuration may be for the at least one beam or cell for which measurement reporting has been suspended.

The measurement configuration may further comprise at least one beam or cell which has not been suspended.

The method may comprise determining a prediction of an event at the network and providing an indication from the network to the further apparatus of the event prediction for use in determining to record measurements.

The method may comprise determining the prediction of the event using a second machine learning model, the prediction having an associated confidence value, the prediction having an associated confidence value, the confidence value indicating a confidence level of the machine learning model for the prediction.

The confidence value may be below a given threshold.

The periodicity of the measurements may depend on the confidence value.

In a fifth aspect there is provided an apparatus comprising at least one processor and at least one memory storing instructions that, when executed by the at least one processor, cause the apparatus at least to receive a measurement configuration at the apparatus to record measurements in a recording window based on a trigger, record one or more measurements based on the measurement configuration in the recording window, determine, based on a condition, to report the recorded measurements after the recording window and report the recorded measurements based on the determining.

The apparatus may be caused to receive an indication at the apparatus from the network to suspend measurement reporting for at least one of a given cell or beam for a time period, wherein the trigger comprises the indication and suspend measurement reporting based on the indication.

The indication to suspend measurement reporting may comprise a validity timer.

The validity timer may comprise at least one of the following: the time period or a start time and a stop time.

The apparatus may be caused to suspend measurement reporting upon receiving the indication to suspend measurement reporting or based on a subsequent event trigger, if the validity timer comprises the time period.

The measurement configuration may be for the at least one beam or cell for which measurement reporting has been suspended.

The measurement configuration may further comprise at least one beam or cell which has not been suspended.

The recording window may be a function of the validity timer.

The apparatus may be caused to determine a prediction of an event and determine to record measurements during the recording window based on the prediction of the event.

The apparatus may be caused to determine the prediction of the event at the user equipment using a machine learning model, the prediction having an associated confidence value, the confidence value indicating a confidence level of the machine learning model for the prediction.

The apparatus may be caused to receive an indication from the network of the predicted event, the prediction having an associated confidence value, the confidence value indicating a confidence level of the machine learning model for the prediction.

The confidence value may be below a given threshold.

The periodicity of the measurements may depend on the confidence value.

The apparatus may be caused to determine to report the recorded measurements if the predicted event does not occur.

The apparatus may be caused to determine that an event has occurred with no prediction and report the recorded measurements from the user equipment to the network based on the determining.

In a sixth aspect there is provided an apparatus comprising at least one processor and at least one memory storing instructions that, when executed by the at least one processor, cause the apparatus at least to provide a measurement configuration to a user equipment by the apparatus to record measurements in a recording window based on a trigger and receive recorded measurements at the apparatus from the user equipment.

The apparatus may be caused to determine, based on a first machine learning model, to suspend measurement reporting for at least one given cell or beam for a first time period and means for providing an indication to the user equipment by the apparatus to suspend measurement reporting for the at least one of a given cell or beam, wherein the trigger comprises the indication.

The indication to suspend measurement reporting may comprise a validity timer.

The recording window may be a function of the validity timer.

The validity timer may comprise at least one of the following: a time period or a start time and a stop time.

The measurement configuration may be for the at least one beam or cell for which measurement reporting has been suspended.

The measurement configuration may further comprise at least one beam or cell which has not been suspended.

The apparatus may be caused to determine a prediction of an event at the network and provide an indication from the network to the further apparatus of the event prediction for use in determining to record measurements.

The apparatus may be caused to determine the prediction of the event using a second machine learning model, the prediction having an associated confidence value, the prediction having an associated confidence value, the confidence value indicating a confidence level of the machine learning model for the prediction.

The confidence value may be below a given threshold.

The periodicity of the measurements may depend on the confidence value.

In a seventh aspect there is provided a computer readable medium comprising instructions which, when executed by an apparatus, cause the apparatus to perform at least the following: receiving a measurement configuration at the apparatus to record measurements in a recording window based on a trigger, recording one or more measurements based on the measurement configuration in the recording window, determining, based on a condition, to report the recorded measurements after the recording window and reporting the recorded measurements based on the determining.

The apparatus may be caused to perform receiving an indication at the apparatus from the network to suspend measurement reporting for at least one of a given cell or beam for a time period, wherein the trigger comprises the indication and suspending measurement reporting based on the indication.

The indication to suspend measurement reporting may comprise a validity timer.

The validity timer may comprise at least one of the following: the time period or a start time and a stop time.

The apparatus may be caused to perform suspending measurement reporting upon receiving the indication to suspend measurement reporting or based on a subsequent event trigger, if the validity timer comprises the time period.

The measurement configuration may be for the at least one beam or cell for which measurement reporting has been suspended.

The measurement configuration may further comprise at least one beam or cell which has not been suspended.

The recording window may be a function of the validity timer.

The apparatus may be caused to perform determining a prediction of an event and determining to record measurements during the recording window based on the prediction of the event.

The apparatus may be caused to perform determining the prediction of the event at the user equipment using a machine learning model, the prediction having an associated confidence value, the confidence value indicating a confidence level of the machine learning model for the prediction.

The apparatus may be caused to perform receiving an indication from the network of the predicted event, the prediction having an associated confidence value, the confidence value indicating a confidence level of the machine learning model for the prediction.

The confidence value may be below a given threshold.

The periodicity of the measurements may depend on the confidence value.

The apparatus may be caused to perform determining to report the recorded measurements if the predicted event does not occur.

The apparatus may be caused to perform determining that an event has occurred with no prediction and means for reporting the recorded measurements from the user equipment to the network based on the determining.

In an eighth aspect there is provided a computer readable medium comprising instructions which, when executed by an apparatus, cause the apparatus to perform at least the following: providing a measurement configuration to a user equipment by the apparatus to record measurements in a recording window based on a trigger and receiving recorded measurements at the apparatus from the further user equipment.

The apparatus may be caused to perform determining, based on a first machine learning model, to suspend measurement reporting for at least one given cell or beam for a first time period and providing an indication to the further apparatus from the network to suspend measurement reporting for the at least one of a given cell or beam, wherein the trigger comprises the indication.

The indication to suspend measurement reporting may comprise a validity timer.

The recording window may be a function of the validity timer.

The validity timer may comprise at least one of the following: a time period or a start time and a stop time.

The measurement configuration may be for the at least one beam or cell for which measurement reporting has been suspended.

The measurement configuration may further comprise at least one beam or cell which has not been suspended.

The apparatus may be caused to perform determining a prediction of an event at the network and providing an indication from the network to the further apparatus of the event prediction for use in determining to record measurements.

The apparatus may be caused to perform determining the prediction of the event using a second machine learning model, the prediction having an associated confidence value, the prediction having an associated confidence value, the confidence value indicating a confidence level of the machine learning model for the prediction.

The confidence value may be below a given threshold.

The periodicity of the measurements may depend on the confidence value.

In a ninth aspect there is provided a non-transitory computer readable medium comprising program instructions for causing an apparatus to perform at least the method according to the third or fourth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example 5GS communication system;

FIG. 2 shows a schematic diagram of an example mobile communication device;

FIG. 3 shows a schematic diagram of an example control apparatus;

FIG. 4 shows a illustration of RSRP against time for an A3 event;

FIG. 5 shows a schematic illustration of a ML model stetting the suspend state of a UE;

FIG. 6a shows a timeline of the operation of a suspend state;

FIG. 6b shows a timeline of the operation of a suspend state;

FIG. 7 shows a flowchart of a method according to an example embodiment;

FIG. 8 shows a flowchart of a method according to an example embodiment;

FIG. 9 shows a schematic diagram of a timer for unsetting suspend state according to an example embodiment;

FIG. 10 shows a timeline for the setting of a suspend state according to an example embodiment;

FIG. 11a shows a flowchart for a method of mobility event triggered data collection according to an example embodiment;

FIG. 11b shows a flowchart for a method of suspend event triggered data collection according to an example embodiment;

FIG. 12 shows a timeline for recording and reporting measurements triggered by predicting mobility events;

FIG. 13 shows a timeline for recording and reporting measurements triggered by suspend events;

FIG. 14 shows a signalling diagram between a UE and a gNB according to an example embodiment;

FIG. 15 shows a signalling diagram between a UE and a gNB according to an example embodiment;

FIG. 16 shows a signalling diagram between a UE and a gNB according to an example embodiment.

### DETAILED DESCRIPTION

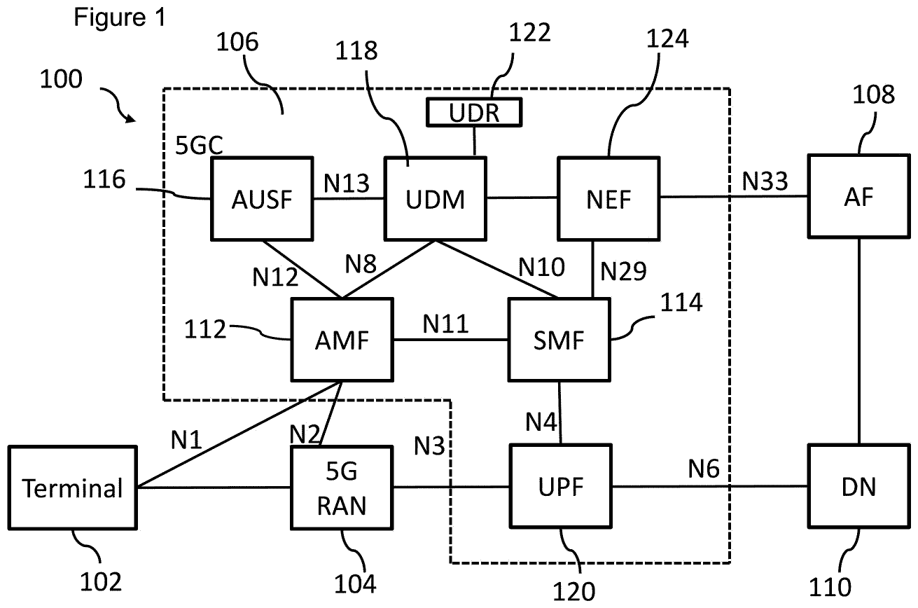

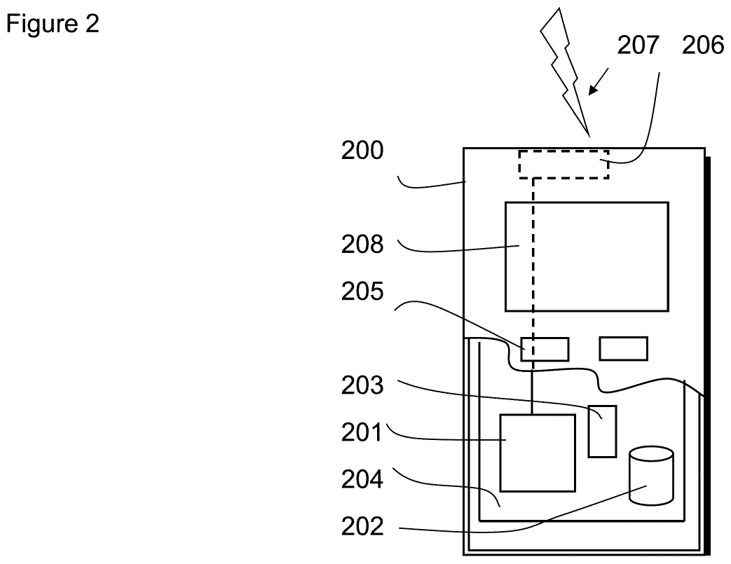

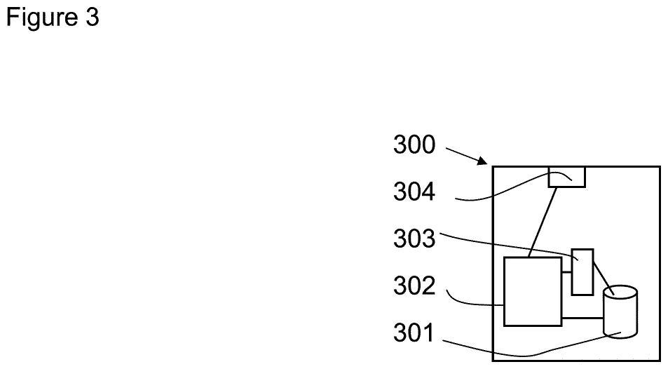

Before explaining in detail the examples, certain general principles of a wireless communication system and mobile communication devices are briefly explained with reference to FIG. 1, FIG. 2 and FIG. 3 to assist in understanding the technology underlying the described examples.

An example of a suitable communications system is the 5G or NR concept. Network architecture in NR may be similar to that of LTE-advanced. Base stations of NR systems may be known as next generation NodeBs (gNBs). Changes to the network architecture may depend on the need to support various radio technologies and finer Quality of Service (QOS) support, and some on-demand requirements for e.g. QoS levels to support Quality of Experience (QoE) for a user. Also network aware services and applications, and service and application aware networks may bring changes to the architecture. Those are related to Information Centric Network (ICN) and User-Centric Content Delivery Network (UC-CDN) approaches. NR may use Multiple Input-Multiple Output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

FIG. 1 shows a schematic representation of a 5G system (5GS) 100. The 5GS may comprise a user equipment (UE) 102 (which may also be referred to as a communication device or a terminal), a 5G radio access network (5GRAN) 104, a 5G core network (5GCN) 106, one or more internal or external application functions (AF) 108 and one or more data networks (DN) 110.

An example 5G core network (CN) comprises functional entities. The 5GCN 106 may comprise one or more Access and mobility Management Functions (AMF) 112, one or more session management functions (SMF) 114, an authentication server function (AUSF) 116, a Unified Data Management (UDM) 118, one or more user plane functions (UPF) 120, a Unified Data Repository (UDR) 122 and/or a Network Exposure Function (NEF) 124. The UPF is controlled by the SMF (Session Management Function) that receives policies from a PCF (Policy Control Function).

The CN is connected to a UE via the Radio Access Network (RAN). The 5GRAN may comprise one or more gNodeB (gNB) Distributed Unit(DU) functions connected to one or more gNodeB (gNB) Centralized Unit(CU) functions. The RAN may comprise one or more access nodes.

A User Plane Function (UPF) referred to as PDU Session Anchor (PSA) may be responsible for forwarding frames back and forth between the DN and the tunnels established over the 5G towards the UE(s) exchanging traffic with the DN.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, voice over IP (VoIP) phones, portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), smart devices, wireless customer-premises equipment (CPE), or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts, and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

FIG. 3 shows an example of a control apparatus 300 for a communication system, for example to be coupled to and/or for controlling a station of an access system, such as a RAN node, e.g. a base station, eNB or gNB, a relay node or a core network node such as an MME or Serving Gateway (S-GW) or Packet Data Network Gateway (P-GW), or a core network function such as AMF/SMF, or a server or host. The method may be implemented in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

The following relates to measurement reporting savings. Existing mechanisms of UE measurement reporting configurations involve, e.g., reporting configuration for baseline handover (BHO).

For non Lower layer Triggered Mobility (LTM) (e.g., BHO, conditional handover (CHO), etc.), measurement reports are sent as an RRC message. The triggering of those reports and related mechanisms are described in 3GPP specifications.

A UE may be configured by the network to report measurements for up to N measurement IDs where N is an integer value and N is decided based on the UE capability. For example, a list of “measIdToAddMod” is configured to the UE, where each entry in the list links a measurement ID (measId) to a measurement object ID (measObjId) and report configuration ID (reportConfigId). Thus, for a given measurement ID, the UE performs a measurement on the measurement object it refers to and applies the criteria provided in the corresponding reporting configuration.

Each reportConfig describes how reporting should happen, e.g. periodically, or event triggered, such as by an A3 event typically used by the network to perform a handover (i.e. a primary/PCell change) of a UE from a source cell to a target cell.

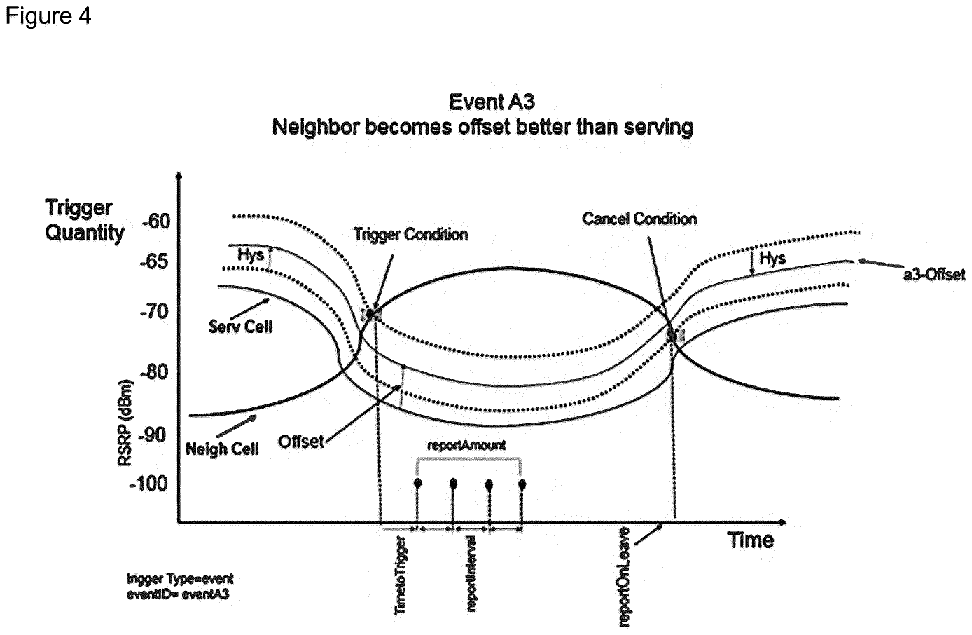

FIG. 4 illustrates an example scenario of how an A3 event works as a RSRP changes over time. In A3, after the trigger condition (e.g., neighbor RSRP is offset better than serving RSRP) is met, and after the time to trigger (TTT) has elapsed while the condition is still true, measurement reports are sent (at a given report interval according to the reporting configuration). It is up to the network to react to those measurement reports e.g., by following up with a baseline HO command (Rel-15) or initiate a preparation for a conditional HO (from Rel-16). The A3 comprises a leaving condition which would also trigger a measurement report by the UE.

A3 is triggered for a specific cell or beam, and the reporting procedures will add the reports for that beam or cell to a UE variable varMeasReport that holds the data that will be sent out as a report. Multiple cells can be reported for the same ReportConfig.

In LTM, L1 measurement reports are sent on the MAC protocol layer in periodic (or semi-static or aperiodic) fashion. The configuration for those reports is delivered to the UE via an RRC message “CSI-ReportConfig”

The IE CSI-ReportConfig is used to configure a periodic or semi-persistent report sent on PUCCH on the cell in which the CSI-ReportConfig is included, or to configure a semi-persistent or aperiodic report sent on PUSCH triggered by DCI received on the cell in which the CSI-ReportConfig is included (in this case, the cell on which the report is sent is determined by the received DCI). The IE CSI-ReportConfigId is used to identify one CSI-ReportConfig (e.g., section 5.2.1 of TS 38.214 and CSI-reportConfig IE of TS 38.331).

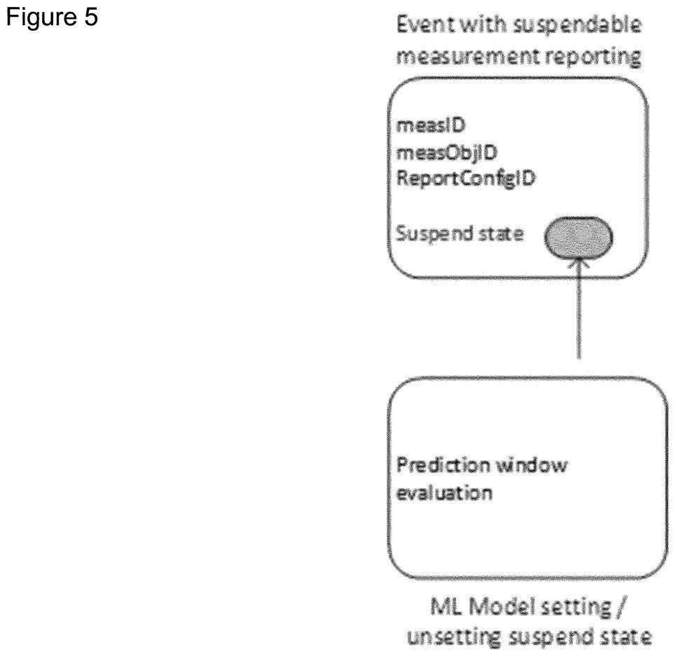

FIG. 5 illustrates a method measurement reporting suspension using a suspend state. A suspend state may be attached to the reporting of a cell or beam. The beam/cell suspend state may be set or unset at a UE by ML models predicting, e.g., that reports will become unnecessary, or by other events, such as serving cell going below an absolute threshold. The suspend state is evaluated at the latest at the time of sending measurement reports to the network.

A suspension mechanism works with triggers and external setting/unsetting actors. In this context an actor may be a ML model in the UE, or the network by way of signaling the UE, or a trigger configuration (that is rule-based mechanism) in the UE linked to a suspend state. In several situations, a suspension state inherently has a duration. However, the current suspend-state-solutions unsuspends reporting when the observed cell/beam goes out of scope

In the case of A3, the event and hence suspend state ends when there is a maximum number of reports configured that are being sent. Alternatively, or in addition, the configured A3 leave condition may be met. Either of those may lead to the removal of the observed cell from the varMeasReportList, that is, unsuspending. In the case of HO, (RRCreconfig) measurement reporting end ends the suspend state.

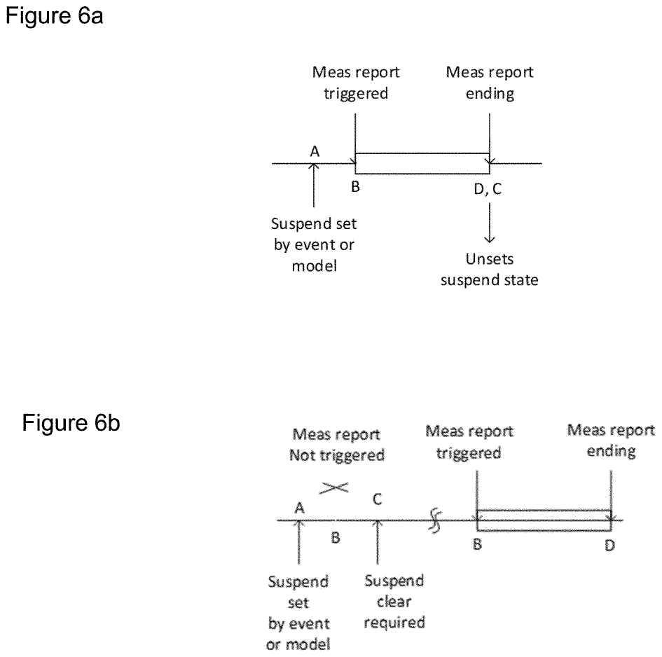

FIG. 6a shows the operation of a suspend state. At point A, the suspend state is set by an event or model. At B, the measurement report is triggered. At points C and D, the suspend state is cleared by the end of reporting. The end of reporting will either correspond to the maximum amount of reports reached, event leave condition encountered, or RRC reconfiguration message.

Other mechanisms that unsuspend the measurement may be in place, such as a measurement trigger linked to unsuspending a suspend state variable.

Current solutions do not consider the prediction horizon that is underlying an ML-model based setting of the suspend state. When a prediction suspends a measurement report for a cell, but in fact the measurement report is never triggered, the actor responsible for setting needs to recognize that the prediction did not materialize and clear the suspend state. Otherwise, the suspend state could be still set for a measurement report trigger to which the prediction was not referring to. This poses a problem in terms of robustness and complexity.

FIG. 6b shows the operation of a suspend state where a measurement report is not triggered at point B. If the suspends state is not cleared, future reports may be suspended even when they are needed.

The suspend mechanism does not foresee reporting of suspend setting events, as the purpose of the mechanism is to save signaling. Nevertheless, the network may benefit from knowledge about the usage of the suspend mechanism and the content of the suspended measurement reports. For example, if model monitoring relies on normal measurement reports, but those get suspended, model monitoring is negatively impacted.

Further, going beyond the suspend mechanism, for a network-side event prediction model, the training or fine-tuning or performance monitoring of the model would benefit from measurements especially in cases predictions are wrong. Setting lower reporting trigger criteria however may create an excessive signaling load and not target the moments where the measurements are really needed. A mechanism needs to be devised to provide the network with training data for suspend events or prediction models where related signaling should not offset the reporting saving gains or create heavy signaling load.

When the suspend mechanism is applied to LTM, the network is able to quickly act and signal on lower layers. Network may also predict and detect a suspend situation.

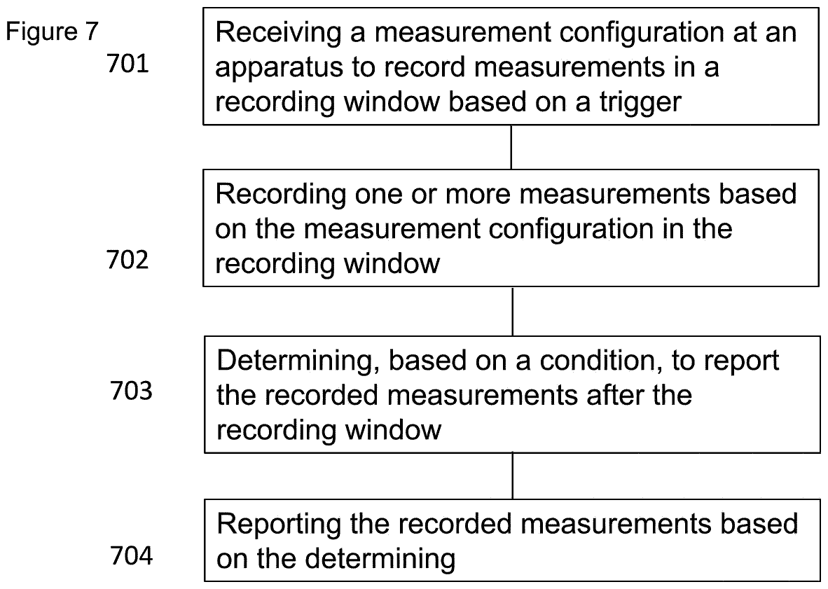

FIG. 7 shows a flowchart of a method according to an example embodiment. The method may be performed at an apparatus such as a UE.

In 701, the method comprises receiving a measurement configuration at the apparatus to record measurements in a recording window based on a trigger.

In 702, the method comprises recording one or more measurements based on the measurement configuration in the recording window.

In 703, the method comprises determining, based on a condition, to report the recorded measurements after the recording window.

In 704, the method comprises reporting the recorded measurements based on the determining.

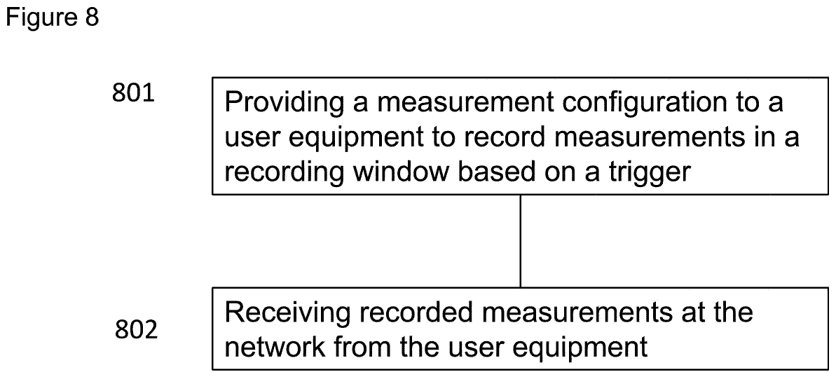

FIG. 8 shows a flowchart of a method according to an example embodiment. The method may be performed, e.g., at a network node.

In 801, the method comprises providing a measurement configuration to a user equipment from a network to record measurements in a recording window based on a trigger.

In 802, the method comprises receiving recorded measurements at the network from the user equipment.

The UE may be configured to record measurements, triggered by setting a suspend state or by an event prediction. The event prediction may be a mobility event prediction. The recorded measurements will include cells/beams for which a suspend state has been set, and optionally other cells/beams. The network may query the recorded measurements when convenient (for instance when the UE is at cell center).

The purpose of doing so becomes apparent when the network is training and tuning a network-side prediction model, or the suspension decision rules (for the network, or for UE deployment).

We note that a recording may start earlier than the trigger occurring, by recording continuously, and discarding recordings when the trigger later does not occur.

The method at a UE may comprise receiving an indication at the apparatus from the network to suspend measurement reporting for at least one of a given cell or beam for a time period, wherein the trigger comprises the indication and suspending measurement reporting based on the indication.

The indication to suspend measurement reporting may comprise a validity timer. The validity timer may comprise at least one of the following: the time period or a start time and a stop time.

In an example embodiment, when setting suspension, a time validity scope is attached to the setting indication. This is an example of a validity timer. The validity scope determines the latest the suspension is lifted.

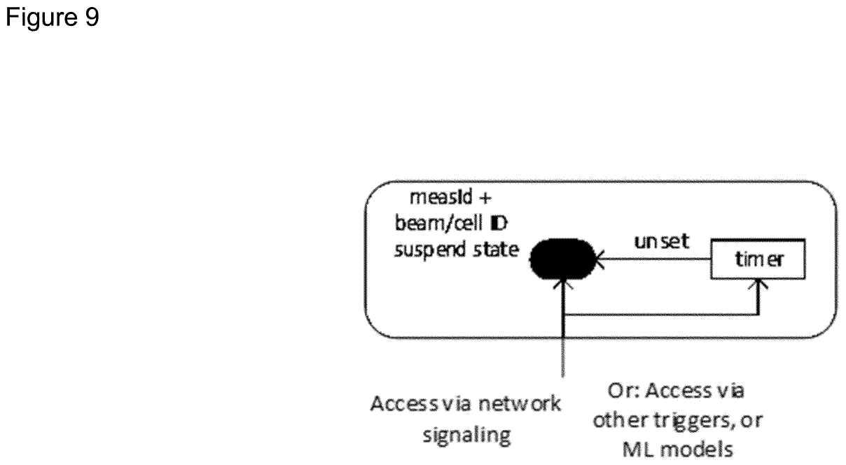

FIG. 9 shows an illustration of a timer for unsetting the suspend state, initialised with a time validity scope of the setting mechanism. In this example embodiment, the validity scope is realised by a timer. Other example validity scope settings may include a start time and a stop time.

When the validity timer comprises the time period, the method may comprise suspending measurement reporting upon receiving the indication to suspend measurement reporting or based on a subsequent event trigger.

In an example embodiment, when the suspend state for a cell or beam is set, it also is configured with a time validity scope. The validity scope in its simplest form may be implemented as the maximal duration starting from the point of setting. When the duration has been exceeded the state is unset. Other scope definitions may also use a starting point in the future and duration for the setting. Other scope definitions may tie the start to a measurement report trigger. This is an example of a subsequent event trigger. Once the suspend state validity scope expires the suspend state is set to false.

The measurement configuration may be for the at least one beam or cell for which measurement reporting has been suspended. The measurement configuration further may comprise at least one beam or cell which has not been suspended. That is, the recorded measurements will include cells/beams for which a suspend state has been set, and optionally other cells/beams.

The validity scope may be determined by the actor which is setting the suspend state.

For instance, if a ML model uses a prediction window of length L, and makes a prediction which leads to determining that measurements for a beam b are not needed within that window, the ML model may set the suspend state for the measurement reporting of beam b, and set a validity scope corresponding to the prediction window length. The ML model may be at the network, or at the UE. For example, a method at a network may comprise determining, based on a first machine learning model, to suspend measurement reporting for at least one given cell or beam for a time period and providing an indication to the user equipment from the network to suspend measurement reporting for the at least one of a given cell or beam, wherein the trigger comprises the indication.

The recording window may be a function of the validity timer (e.g. validity scope plus some margins leading up and after the scope).

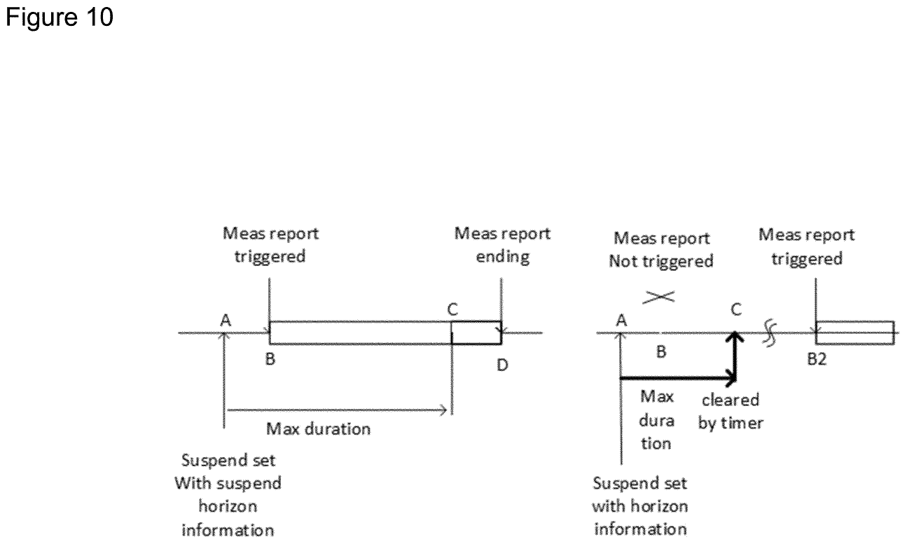

In FIG. 10 two possibilities are shown for the case where the suspend state validity scope is implemented as a timer with a maximal duration. At point A the timer is started, and it elapses at point C. At point C the suspend state is cleared. In the example this leads to that measurement reporting is resumed at point C, as shown in the left side figure. Measurement reporting would end at point D e.g. because maximal amount of reports as been reached. In the right side figure the suspend state is set, but actually no reports happen to be triggered. Therefore the suspend state would be kept set. This would lead to suspension of reports that were triggered at another point B2 at a much later point in time, no longer related to the prediction that was setting the suspend state. However, with the new validity scope mechanism the suspend state will be cleared automatically.

A method may comprise determining a prediction of an event and determining to record measurements during the recording window based on the prediction of the event. Recording may be triggered by a predicted event not matching an observed event The event prediction may be carried out at the network and signalled to the UE. The event prediction may be a mobility event prediction. An event prediction can be also “beam ID will be strongest” or “beam strength will be within a certain range”. An event prediction may also specify a sub-time-window within the prediction window in which the event may occur.

The method may comprise determining the prediction of the event using a machine learning model, the prediction having an associated confidence value, the confidence value indicating a confidence level of the machine learning model for the prediction. The prediction of the event may be determined at the UE or the network. When the prediction of the event is determined at the network, the network may provide an indication of the predicted event to the UE. The determining to record measurements may comprise determining that the predicted event does not match the observed event or may comprise determining that the prediction confidence value may be below a given threshold.

The UE may also report the measurements based on a condition (e.g., reporting configuration, receiving a query from the network or the UE's data storage reaching a threshold).

The advantage, as mentioned, is that the UE reporting is selective to situations of interest of the network. Further, the UE reporting may include measurements which with normal reporting would not have been available, e.g., because normal measurement and reporting configurations would have chosen lower measurement interval, or higher threshold, or limited the amount of reported beams more.

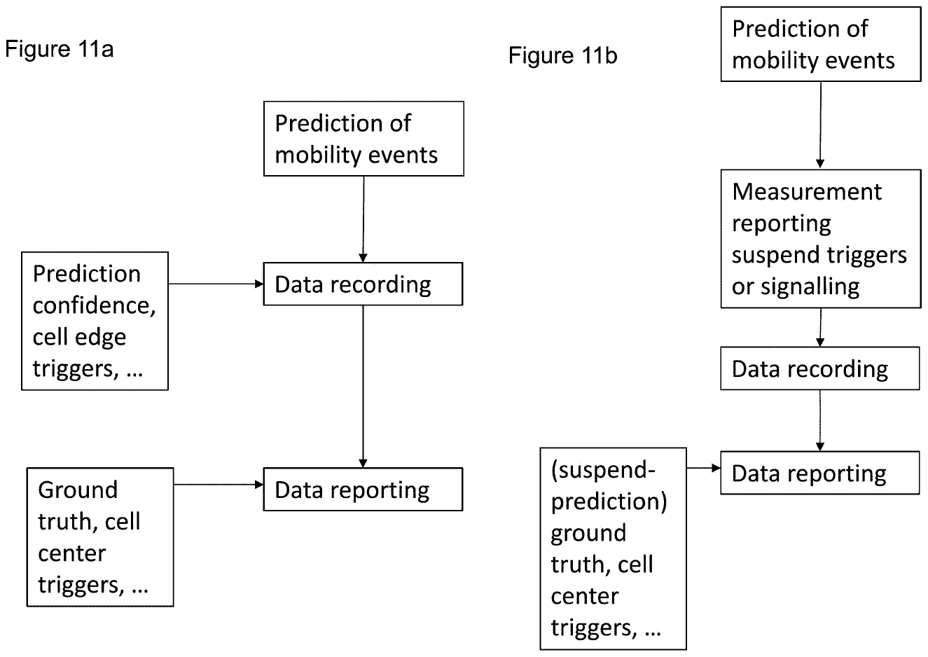

FIG. 11a shows a flowchart according to an example embodiment.

In this example embodiment, the UE is instructed to record measurements, which would serve the purpose of later improving the predictions or monitor the performance of the mobility model. The recording is started and conditioned as when an actor (network or UE ML model) is predicting a mobility event. Mobility event may be for instance a predicted A3 event. For high confidence level of the prediction, no recording of measurements needs to be carried out.

As a result, measurement recording may be done for data relevant to improving predictions.

Alternatively, as shown in the example embodiment of FIG. 11b, the recording action is configured at an earlier time by the network, and linked to dynamic setting of suspend states:

In the example embodiment shown in FIG. 11b, the recording is triggered by suspend state setting. There is no additional signaling for recording the events of interest. Recording non-suspend events requires separate signaling (network-side event prediction) or configuration (UE-side event prediction).

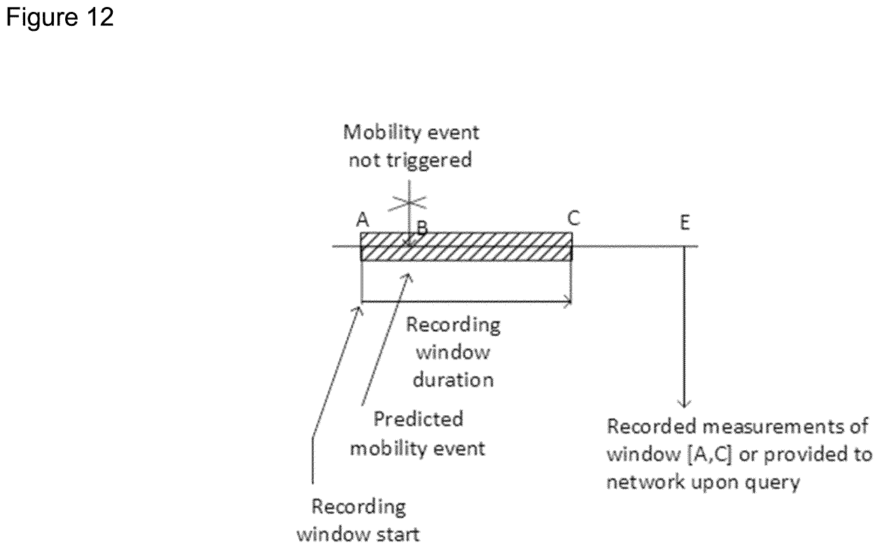

FIG. 12 shows an example timeline of recording and reporting of training data according to a first example embodiment.

A ML model is predicting a mobility event for point B. Here we may assume the model is in the UE. (If the model is in the network, the network may signal the predicted event to the UE, e.g. in the form of a recording window, and the type of predicted event expected in the window). In the example the predicted event is not happening, and hence the UE retains the recording for a later reporting to the network at point E.

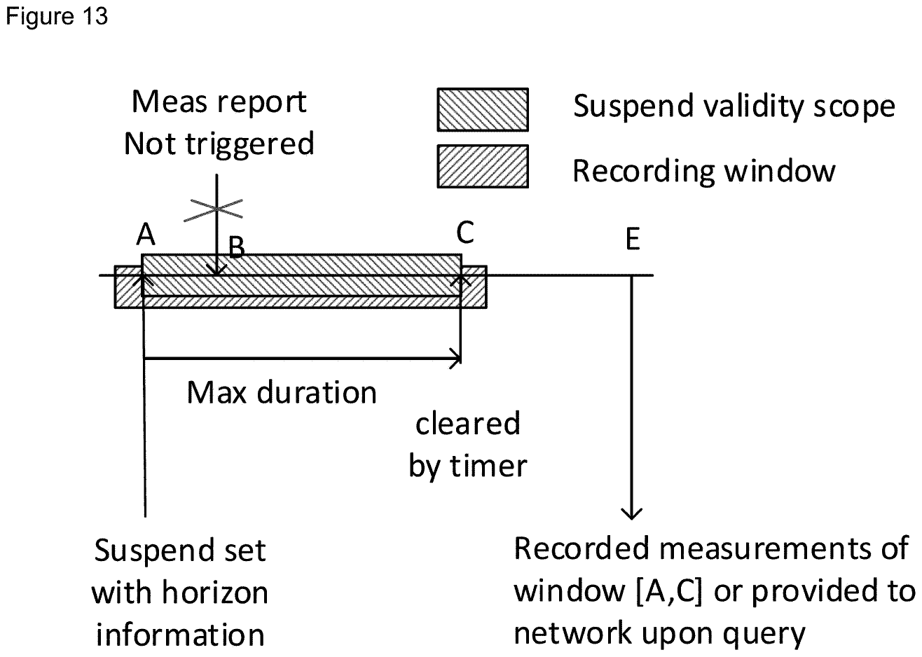

FIG. 13 shows the timeline of a recording for a second example embodiment. The data recording happens here around the validity scope of the suspend state (A . . . C). Data recording is further conditioned to that the predicted event did not take place (B). Therefore, the recording is retained and transmitted to the network at a later point E.

In both the example embodiments discussed above, UE measurements may not be limited to predicted beam/cell IDs. UE measurements may be collected as said also when signal levels are below mobility event reporting thresholds that are used for the event prediction.

A separate “recording measurement configuration” can be defined by the network, detailing e.g. minimal levels of signals required for recording. The measurement recordings may indicate that configured beams/cells could not be identified, that is, minimal signal levels were not observed.

The periodicity of the measurements may depend on the confidence value. For example, sparse measurements can be configured, which optimize the sampling rate for the desired purpose of training the model. The sparsity level of the data collection can be adjusted to the confidence level or observed accuracy of the prediction. That is, instead of a binary decision that there is no need for data collection, if the confidence level surpasses a certain threshold τ (e.g. 90%), there may be also multiple thresholds for the confidence level. For instance and without loss of generality, if it is below threshold τ₁, a full-scheme data collection would be required. If it is between τ₁ and τ₂, a sparse data collection would be more suitable, and if it is above threshold τ₂, there may be no need for the data collection. The number of threshold regions and their corresponding values can either be fixed or set dynamically, which in the latter case, it becomes merely a matter of optimization task, which can be realized heuristically or through various available statistical learning methods.

The data reporting may be conditioned on the prediction of mobility events. Data reporting may be conditioned on prediction of events such as beam ID is strongest. Data reporting may be conditioned on prediction of beam strength, e.g. measured as RSRP, having values in a configured range.

The method may comprise determining to report the recorded measurements if the predicted event does not occur. In an example embodiment, if the predicted event does not come to pass (wrong prediction or “false positive”), the measurement recordings are kept. This serves the purpose of collecting training or fine-tuning data for improving the prediction mechanism, by collecting data that serves as ground truth for wrong predictions. It helps in prediction failure root-cause analysis. This is applicable to a UE side model, and a network side model. In the context of suspendable measurement reporting one advantage is that the recorded data covers the events that would cause suspension of measurements.

The method may comprise determining that an event has occurred with no prediction and means for reporting the recorded measurements from the user equipment to the network based on the determining. For example, if mobility events happen but were not known to be predicted (“false negative”), the measurement recordings are kept. This variant requires that the UE keeps recording data, even if no events are predicted. This is applicable to a UE side model, or to a network side model combined with signaling where the UE is informed about predicted events (or periods of no anticipated events).

If the UE has a recording amount limit, the recording may happen in circular fashion (discarding older recordings), making latest measurements available. Alternatively, the data recording may be disabled when the buffer is full (serving energy saving), such that earlier measurements are kept, and when the buffer is full no new measurements are done or recorded.

The network may query the recorded measurements when convenient (for instance when the UE is at cell center). This has the advantage that measurements can be relayed to the network with higher spectral efficiency compared to cell-edge reporting. Alternatively, the UE may send the recorded measurements based on a configured trigger, such as “serving cell exceeds threshold”, or data buffer threshold exceeded.

Signalling is introduced, where the network may set the suspension state of reports, temporarily disabling reporting for selected beams (as opposed to events in the UE or actors such as ML models in the UE setting the suspend state). This has the advantage of minimization of the reporting load without performing RRC reconfigurations. For L1/2 reporting, it allows to emulate aperiodic reporting of beams, but with finer granularity suspending specific beams.

In one embodiment variant, the network stops sending dedicated reference signals (DMRS) to the UE, for the period where it indicates that measurement reports are to be suspended. This works in case the UE-side recording of measurements is disabled, and a fall-back clearing of the suspend state at the UE is not expected to happen. The advantage for be that of saving DL transmission resources.

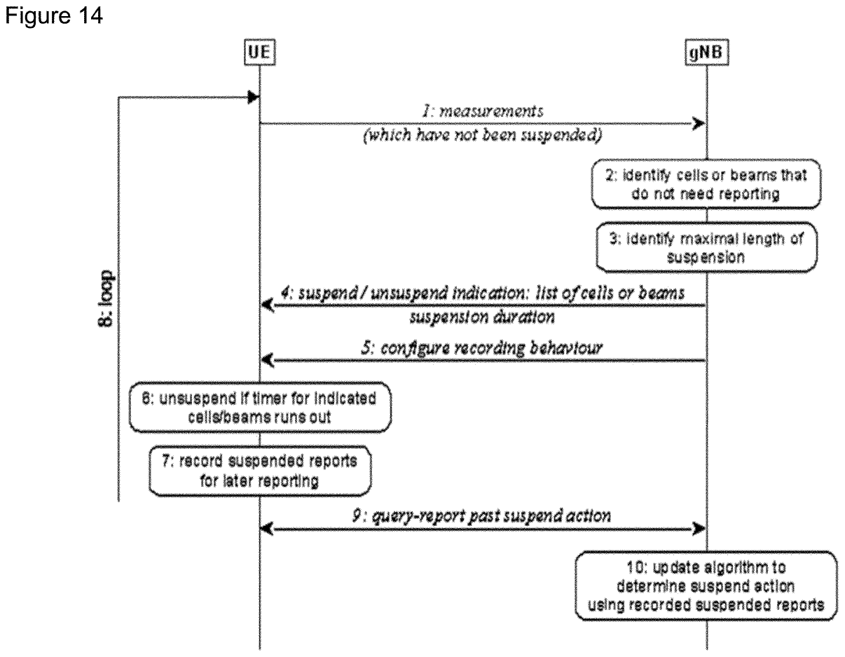

FIG. 14 shows a signalling diagram according to an example embodiment.

In step 0 (not shown), the NW configures reportConfig to the UE.

In step 1, the UE sends measurement (e.g., RRM measurements) to NW which are not suspended.

In step 2, a prediction of events in a future window is carried out in NW. Since, the network is aware of the reportConfig that have been configured to the UE, consequently, the network can deduce that reports for some beams/cells are likely to be triggered, but not necessarily needed. Network can anticipate when to-suspend reporting would start. The suspend state will refer to the measId to which the reportConfig belongs.

In step 3, the prediction of events yields a time horizon, in which the prediction can be considered accurate. This time horizon will be used to set the suspension duration. The time horizon may be for instance, determined as the window length which produces still 90% confidence of accurate prediction.

In step 4, the suspension of cells/beams is signalled, along with the maximal suspension duration. Suspension duration may include anticipated start time of suspension.

In an alternative embodiment the steps 2,3,4 may be carried out in the UE.

In step 5, the network configures the UE whether suspend action shall trigger measurement recording. There can different ways to perform this operation: a) statically: This step may be carried out statically during configuring the UE along with reportConfig before step 1 and b) dynamically: It can be carried out dynamically as step 5, for instance if the model prediction of step 2 yielded low confidence, and the network intends to improve the model performance for the prevailing settings.

In step 6, the UE sets suspend states for the measId, for the indicated cells/beams, with (optional: anticipated start time and) maximal suspend duration. When the timer for a measId+cell/beam runs out, the suspend state is cleared.

In step 7, if configured, the UE records measurements, which may be the reports that have been suspended. The duration of the recording may be that of the suspend state validity timer. In alternative embodiments, additional measurements are recorded, spanning a duration, e.g. double of the suspend validity timer.

In step 8, the method may continue with step 1 or step 9, depending e.g. on whether the UE is still in a cell edge region where HO events are common, or not, respectively.

In step 9, once the UE is no longer in a HO situation or able to easily report recorded suspended reports, the network polls those.

In step 10, the network uses suspended reports to verify and improve its prediction algorithm of step 2.

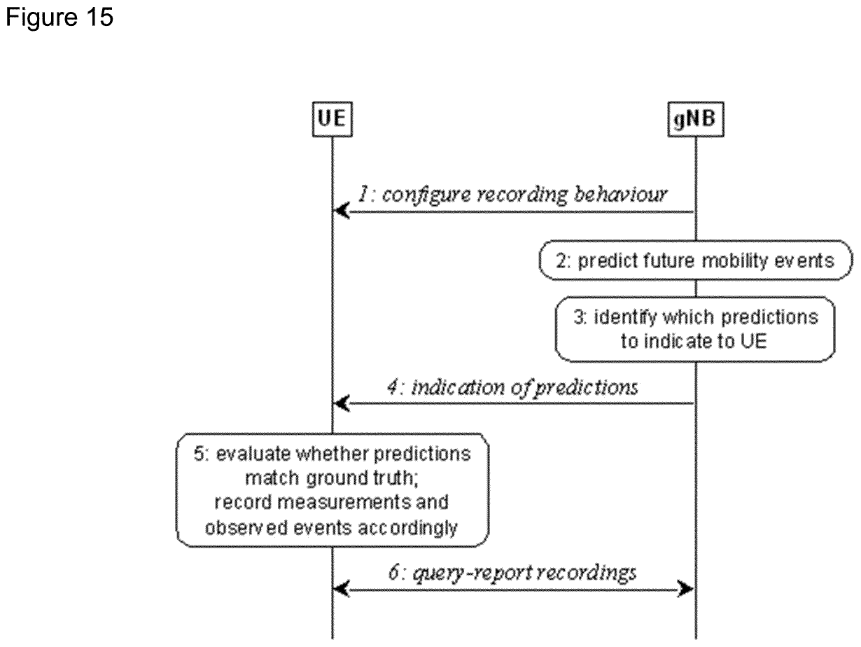

FIG. 15 shows a sequence of steps for an example embodiment, where prediction of events is happening at the network side.

In step 1, the NW configures conditions to record data in the UE. The configuration also may contain configuration for what beams and cells to record.

In steps 2 and 3, the network performs predictions, and determines whether it wants the UE to collect data for those. The network may for instance predict an A3 event, but predict it with low confidence. Or the network may wish to gather more training data for this prevailing situation, but only for cases where its predictions are not met, or for cases where events happen but it did not make predictions.

In step 4, the network indicates the predictions to the UE. The network may indicate for instance that in a future time window there will be an A3 event between two cells. The indication of the predictions may indicate also a time range where each prediction is happening.

In step 5, the UE records measurements as configured (e.g. beam RSRPs). The UE may also record the observed events (e.g. A3). The UE also evaluates the configured conditions, matching predictions to observations (e.g. did A3 happen). The UE keeps the measurements according to its evaluations for later reporting.

In step 6, recordings are reported.

The above described steps may work not only for mobility events, but also for simpler predictions. For example, the prediction of K-strongest beam in the future window, or prediction of RSRP of beams. The value K could be an integer number of 1, 2, etc.

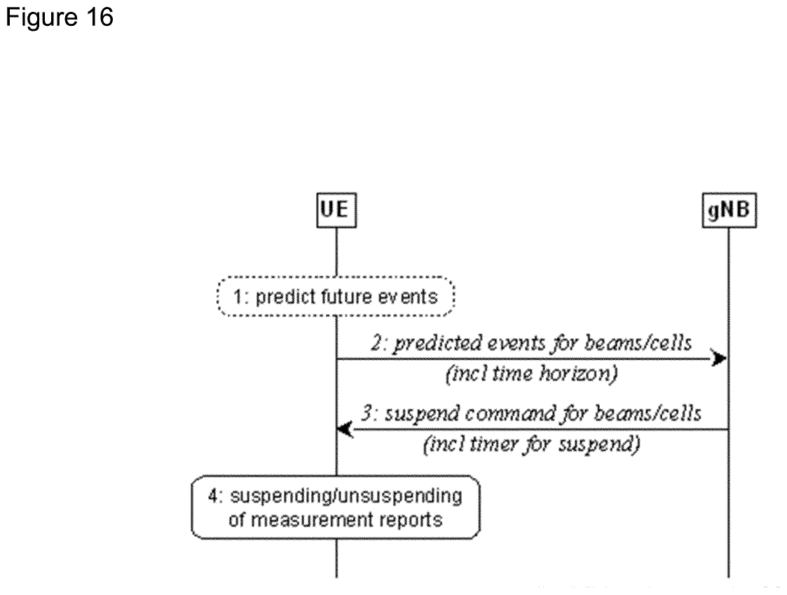

FIG. 16 shows a signalling diagram for an embodiment where there is UE-side prediction but network-side suspension.

In step 1, the UE performs predictions.

In step 2, the UE provides an indication of predicted events for beams and/or cells (including the time horizon with reference to step 3 of FIG. 14).

The gNB then provides the suspend commend for beams/cells to the UE in step 3 based on the indication received form the UE.

In step 4, the UE performs suspending/unsuspending of measurement reports according to the suspend command.

In this embodiment, suspend validity scope setting and recording setting may be controlled by the UE, or by the network.

Embodiments may ensure that recording of measurements are cleared before a new suspend event occurs.

Making mobility-event-prediction-model relevant training data available by recording and reporting in efficient manner.

An apparatus may comprise means for receiving a measurement configuration at the apparatus to record measurements in a recording window based on a trigger, means for recording one or more measurements based on the measurement configuration in the recording window, means for determining, based on a condition, to report the recorded measurements after the recording window and means for reporting the recorded measurements based on the determining.

The apparatus may comprise a user equipment, such as a mobile phone, be the user equipment or be comprised in the user equipment or a chipset for performing at least some actions of/for the user equipment.

Alternatively, an apparatus may comprise means for providing a measurement configuration to a user equipment to record measurements in a recording window based on a trigger and means for receiving recorded measurements from the user equipment.

The apparatus may comprise a network node, be the network node or be comprised in the network node or a chipset for performing at least some actions of/for the network node. The network node may implement a gNB.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems such as 6G networks or 5G-Advanced networks. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media. The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus comprising:
at least one processor; and
at least one memory storing instructions that, when executed by the at least one processor, cause the apparatus at least to perform:
receiving a measurement configuration at the apparatus to record measurements in a recording window based on a trigger;
recording one or more measurements based on the measurement configuration in the recording window;
determining, based on a condition, to report the recorded measurements after the recording window; and
reporting the recorded measurements based on the determining.

2. The apparatus according to claim 1, wherein the apparatus is further caused to at least perform:
receiving an indication at the apparatus from the network to suspend measurement reporting for at least one of a given cell or beam for a time period, wherein the trigger comprises the indication; and
suspending measurement reporting based on the indication.

3. The apparatus according to claim 2, wherein the indication to suspend measurement reporting comprises a validity timer.

4. The apparatus according to claim 3, wherein the validity timer comprises at least one of the following: the time period or a start time and a stop time.

5. The apparatus according to claim 4, wherein the apparatus is further caused to at least perform suspending measurement reporting upon receiving the indication to suspend measurement reporting or based on a subsequent event trigger, if the validity timer comprises the time period.

6. The apparatus according to claim 2, wherein the measurement configuration is for the at least one beam or cell for which measurement reporting has been suspended.

7. The apparatus according to claim 5, wherein the measurement configuration to record measurements further comprises at least one beam or cell which has not been suspended.

8. The apparatus according to claim 2, wherein the recording window is a function of the validity timer.

9. The apparatus according to claim 1, wherein the apparatus is further caused to at least perform: determining a prediction of an event and determining to record measurements during the recording window based on the prediction of the event.

10. The apparatus according to claim 9, wherein the apparatus is further caused to at least perform: determining the prediction of the event at the user equipment using a machine learning model, the prediction having an associated confidence value, the confidence value indicating a confidence level of the machine learning model for the prediction.

11. The apparatus according to claim 9, wherein the apparatus is further caused to at least perform: receiving an indication from the network of the predicted event, the prediction having an associated confidence value, the confidence value indicating a confidence level of the machine learning model for the prediction.

12. The apparatus according to claim 10, wherein the confidence value is below a given threshold.

13. The apparatus according to claim 10, wherein the periodicity of the measurements depends on the confidence value.

14. The apparatus according to claim 9, wherein the apparatus is further caused to at least perform: determining to report the recorded measurements if the predicted event does not occur.

15. The apparatus according to claim 1, wherein the apparatus is further caused to at least perform: determining that an event has occurred with no prediction and reporting the recorded measurements from the user equipment to the network based on the determining.

16. An apparatus comprising:
at least one processor; and
at least one memory storing instructions that, when executed by the at least one processor, cause the apparatus at least to perform:
providing a measurement configuration to a user equipment to record measurements in a recording window based on a trigger; and
receiving recorded measurements from the user equipment.

17. The apparatus according to claim 16, wherein the apparatus is further caused to at least perform:
determining, based on a machine learning model, to suspend measurement reporting for at least one given cell or beam for a first time period; and
providing an indication to the user equipment to suspend measurement reporting for the at least one of a given cell or beam, wherein the trigger comprises the indication.

18-20. (canceled)

21. The apparatus according to claim 16, wherein the measurement configuration is for the at least one beam or cell for which measurement reporting has been suspended.

22. (canceled)

23. The apparatus according to claim 16, wherein the apparatus is further caused to at least perform: determining a prediction of an event at the network and providing an indication from the network to the further apparatus of the event prediction for use in determining to record measurements.

24-26. (canceled)

27. A method comprising:
receiving a measurement configuration at an apparatus to record measurements in a recording window based on a trigger;
recording one or more measurements based on the measurement configuration in the recording window;
determining, based on a condition, to report the recorded measurements after the recording window; and
reporting the recorded measurements based on the determining.

28-32. (canceled)
